(19) United States
(12) Patent Application Publication
(10) Pub. No.: US 2026/0003709 A1
(43) Pub. Date: Jan. 1, 2026

(54) ERROR HANDLING MANAGEMENT CORE

(71) Applicant: Advanced Micro Devices, Inc., Santa Clara, CA (US)

(72) Inventors: Vilas Sridharan, Boxborough, MA (US); Magiting Talisayon, Boxborough, MA (US); Kasir Asad Watkins, Fishkill, NY (US)

(73) Assignee: Advanced Micro Devices, Inc., Santa Clara, CA (US)

(21) Appl. No.: 18/754,264

(22) Filed: Jun. 26, 2024

(51) Int. Cl. G06F 11/07

(52) U.S. Cl. CPC G06F 11/0772; G06F 11/0721

(57) ABSTRACT

The disclosed device includes a processor core and a management core. The management core can intercept error interrupts indicating errors for the processor core. The management core can process the error while the processor core continues operations, and can also cloak the error from an operating system. Various other methods, systems, and computer-readable media are also disclosed.

### BACKGROUND

A computing device has various mechanisms to address hardware faults, such as faults relating to a processor core (e.g., a processing unit of a central processing unit (CPU) which may have multiple processing units). For instance, an interrupt system allows interrupts to take precedence over normal program instruction execution. Further, a system such as Machine Check Architecture (MCA) allows detecting and reporting hardware errors to an operating system (OS) of the computing device. However, reporting every error to the OS can be undesirable and unnecessary for certain errors that can be corrected.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for an error handling processor.

FIGS. 2A-C are diagrams of error cloaking.

FIG. 3 is a flow diagram of an exemplary method for managing errors with an error handling processor.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a processor having a management core for error handling without visibility to an operating system. As will be explained in greater detail below, implementations of the present disclosure include a management core that can process machine errors independently from a processor core as well as cloaking the error from an operating system as needed. The systems and methods described herein advantageously allow improved error handling.

Features from any of the implementations described herein can be used in combination with one another in accordance with the general principles described herein. These and other implementations, features, and advantages will be more fully understood upon reading the following detailed description in conjunction with the accompanying drawings and claims.

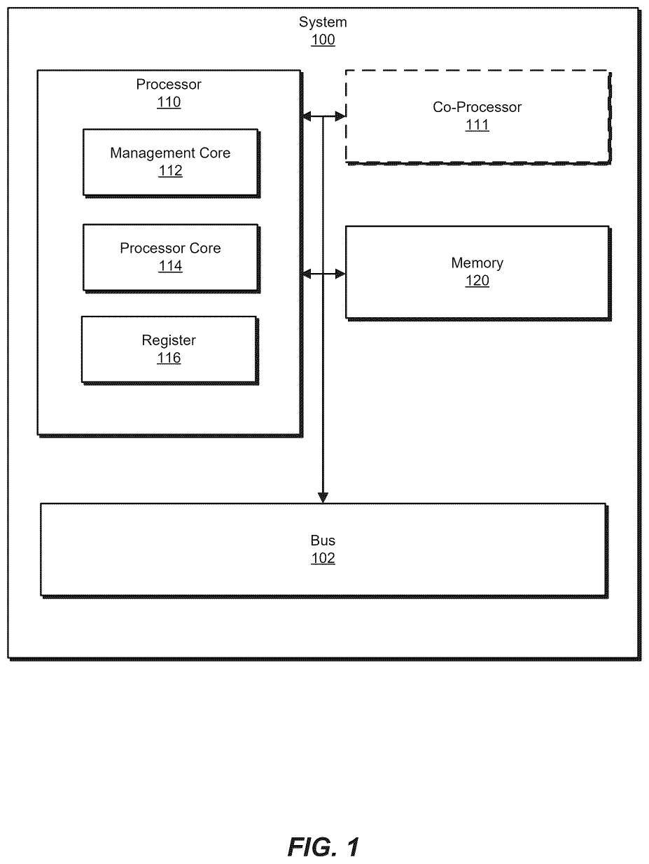

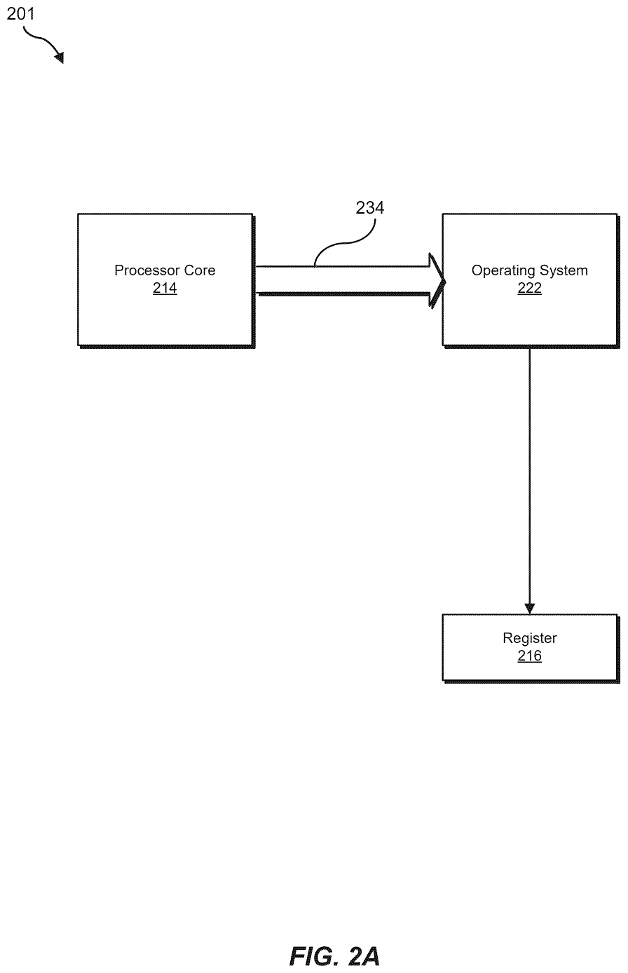

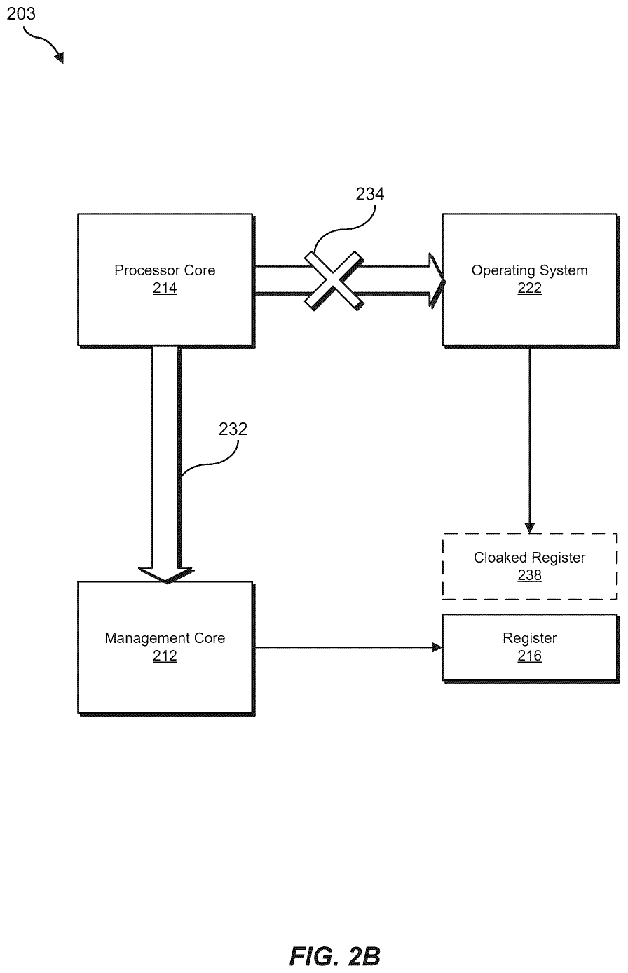

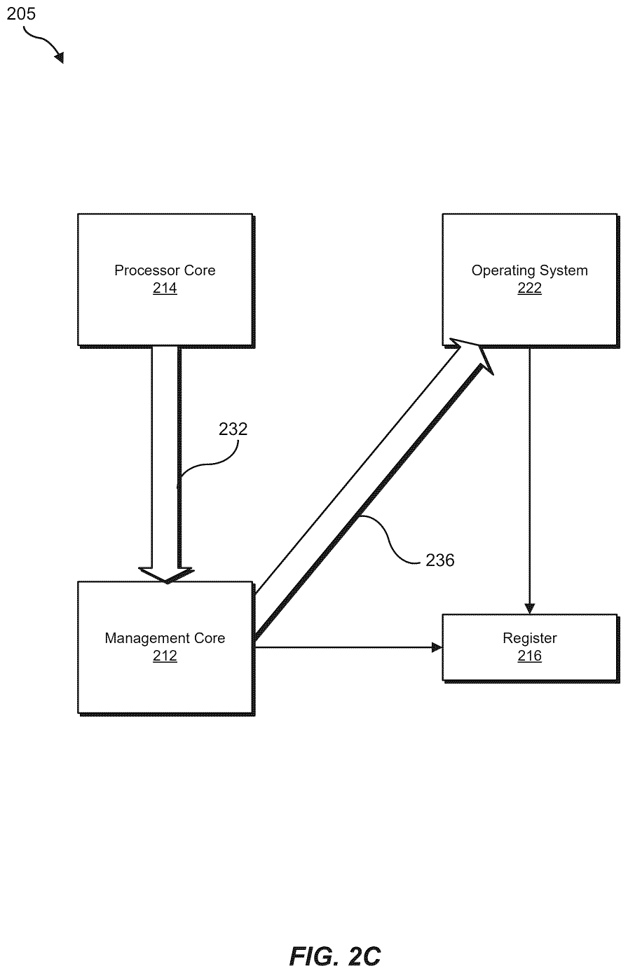

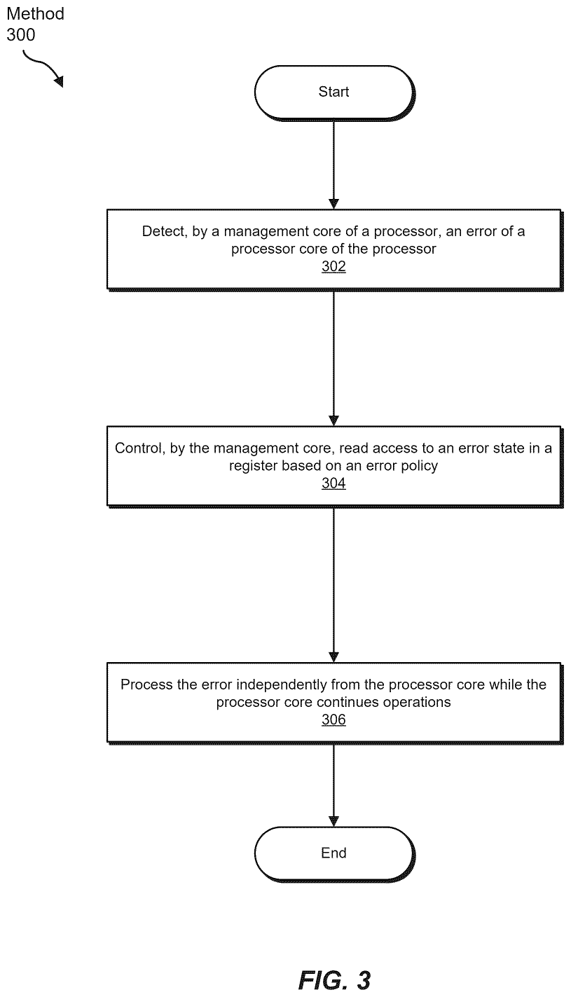

The following will provide, with reference to FIGS. 1-3, detailed descriptions of example architectures with an error handling processor core. Detailed descriptions of example systems will be provided in connection with FIG. 1. Detailed descriptions of error cloaking will be provided in connection with FIGS. 2A-2C. Detailed descriptions of corresponding computer-implemented methods will also be provided in connection with FIG. 3.

FIG. 1 is a block diagram of an example system 100 for an error handling processor core. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some examples, system 100 can be coupled to a display through bus 102.

As further illustrated in FIG. 1, processor 110 includes a management core 112, a processor core 114, and a register 116. A core can correspond to an individual processor of a processor chip having multiple cores. Management core 112 corresponds to a core that in some implementations is configured for management tasks, such as error handling. Processor core 114 corresponds to a core of processor 110 that is configured for processing tasks, such as running programs. Register 116 corresponds to a local storage of processor 110 that in some implementations can be used to storing an error state and/or other error information. As will be described further below, management core 112 can manage hardware errors of processor core 114, as indicated in register 116, independently from processor core 114 to allow, in some examples, processor core 114 to continue executing tasks normally.

FIG. 2A illustrates an error scenario 201 for a processor core 214 (corresponding to processor core 114) and a register 216 (corresponding to register 116) with respect to an operating system 222. Processor core 214 can encounter an error, the details of which can be stored in register 216. In some examples, register 216 and/or an associated error architecture can send an interrupt to processor core 214 to inform processor core 214 of the error, although in other examples, other messages and/or interrupts can inform processor core 214.

In response to an error, processor core 214 can report the error to operating system 222 via an error interrupt 234. Operating system 222 can read register 216 for error information and perform a follow up action. For example, operating system 222 can instruct processor core 214 to handle the error, which can require processor core 214 to pause executing tasks (e.g., as provided by operating system 222) or alternatively, operating system 222 can account for an unavailability of processor core 214 as it handles the error. In addition, operating system 222 can notify a user and/or log error information. However, in some instances, having operating system 222 to initially view/respond to errors can be inefficient.

FIG. 2B illustrates an error scenario 203 which can include a management core 212 (corresponding to management core 112). In FIG. 2B, after processor core 214 encounters an error, error interrupt 234 to operating system 222 can be suppressed, such as by actively blocking and/or intercepting error interrupt 234, or omitting error interrupt 234 from a normal error flow. Rather, an error interrupt 232 can be sent to management core 212 to allow visibility of the error to management core 212 (and/or a firmware running on management core 212) before operating system 222. Management core 212 can access register 216 to read the error state/information and address the error accordingly, and more specifically to process the error independently from (and in parallel to) processor core 214. Processing the error can include, for example, taking action in response to the error (e.g., instructing processor core 214 to perform a debugging and/or corrective action, pause operations, and/or shut down), reporting the error as needed, etc. In some implementations, instead of and/or in addition to receiving error interrupts (e.g., error interrupt 232), management core v12 can poll for errors, such as by periodically accessing register 216. In some examples, this allows processor core 214 to continue operations such as executing tasks without having to directly address the error. For instance, processor core 214 can continue after sending error interrupt 232, although in other examples processor core 214 can wait until management core 212 instructs processor core 214 to continue and in yet further examples, management core 212 can instruct processor core 214 to pause (or otherwise not allow processor core 214 to continue operations) based on the error.

In some implementations, management core 212 can include an error policy that controls error visibility to operating system 222. For example, the error policy can be microcode (e.g., firmware in some implementations) and/or other firmware or logic in management core 212 that can be programmable or otherwise configurable. The error policy can indicate which errors and/or types of errors are not visible to operating system 222 and are cloaked (e.g., via interrupts and/or polling), and which errors and/or error types are visible to operating system 222 and are uncloaked. Further, in some implementations, the error policy can be independent from management core 212 (e.g., management core 212 can implement an independent policy for receiving interrupts and/or polling for errors).

In some implementations, cloaking an error includes suppressing an error interrupt to operating system 222 (as described above), and further prevent operating system 222 from reading the error state for the error. In some implementations, when operating system attempts to read register 216, rather than explicitly blocking any read attempts, operating system 222 can instead be redirected to cloaked register 238, which in some examples can refer to a default returned value rather than a physical or logical register, although in other examples can refer to a physical or logical register holding the default value. Accordingly, management core 212 can process the error without visibility to operating system 222 in accordance with the error policy.

In some examples, errors can be cloaked by default, and management core 212 can uncloak errors based on the error policy. For example, certain errors can be uncloaked upon management core 212 first encountering the error, although in other examples management core 212 can later uncloak the error (e.g., in response to correcting the error and/or reaching another milestone, such as an escalation if the error cannot be addressed, which can further be defined in the error policy). FIG. 2C illustrates an error scenario 205 in which management core 212 has uncloaked the error in response to receiving error interrupt 232.

In some implementations, uncloaking the error can include sending an error interrupt (e.g., error interrupt 236 that is separate from error interrupt 232) to operating system 222 as well as allow operating system 222 to access register 216 to read the error state for the error (which in some implementations allows operating system 222 to poll for errors). As illustrated in FIG. 2C, management core 212 can send error interrupt 236 to operating system 222, although in other implementations, uncloaking the error can include allowing rather than suppressing error interrupt 234 (in FIGS. 2A and 2B). Accordingly, management core 212 can uncloak the error in accordance with the error policy.

FIG. 3 is a flow diagram of an exemplary method 300 for error handling with a management core. The steps shown in FIG. 3 can be performed by any suitable computer-executable code and/or computing system, including the system(s) illustrated in FIGS. 1 and/or 2A-2C. In one example, each of the steps shown in FIG. 3 represent an algorithm whose structure includes and/or is represented by multiple sub-steps, examples of which will be provided in greater detail below.

As illustrated in FIG. 3, at step 302 one or more of the systems described herein detect, by a management core of a processor, an error of a processor core of the processor. For example, management core 112 can receive an error interrupt associated with processor core 114 and/or management core 112 can poll register 116 for error information/state.

The systems described herein can perform step 302 in a variety of ways. In one example, an update to register 116 can trigger an error interrupt, which can be directed to processor core 114, and processor core 114 can send another error interrupt or forward the initial error interrupt to management core 112. In other implementations, the error can trigger an error interrupt to management core 112 directly. In yet other implementations, management core 112 can periodically read/scan register 116 for changes or new error information (not previously addressed), which can further be in response to certain events/triggers.

At step 304 one or more of the systems described herein control, by the management core, read access to an error state in a register based on an error policy. For example, management core 112 can control read access to the error state in register 116.

The systems described herein can perform step 304 in a variety of ways. In one example, management core 212 can prevent read access to register 216 for operating system 222, although in other examples management core 212 can further prevent read access by other agents to register 216 as needed (e.g., based on an error policy). As described herein, management core 212 can cloak the error from operating system 222, which in some examples can include suppressing interrupts and/or preventing error polling.

At step 306 one or more of the systems described herein process the error independently from the processor core while the processor core continues operations. For example, management core 112 can process the error independently from and/or in parallel to processor core 114.

The systems described herein can perform step 306 in a variety of ways. In one example, management core 112 can instruct processor core 114 to continue operations (e.g., processor core 114 can wait on the instruction from management core 112 to continue), although in other examples, processor core 114 can continue operations until instructed otherwise by management core 112 (e.g., management core 112 can confirm the processor core 114 continues or otherwise instructs processor core 114 to pause). In yet further instructions, management core 112 can further instruct processor core 114 with tasks directed to addressing the error (e.g., flushing appropriate data structures/pipelines, powering off, etc.).

The management core can further uncloak the error as indicated by the error policy. For example, the error policy can indicate conditions for reporting the error, such that management core 212 can uncloak the error from operating system 222, which in some examples can further include allowing operating system 222 to poll for errors.

As detailed above, the systems and methods provided herein are directed to a Platform First Error Handling architecture (e.g., in which firmware sees all error state prior to exposing it to the operating system) in which the error handling firmware resides in a dedicated management core as opposed to another processing core or execution unit.

The systems and methods described herein can further be applied to a Machine Check Architecture (MCA). When an MCA error occurs, all MCA interrupts and exceptions can be redirected to the firmware, and MCA banks (e.g., registers) are cloaked to the operating system (OS). Once the firmware has seen the error, firmware can make a policy choice on whether to expose that error to the operating system by uncloaking the MCA bank (e.g., allowing the OS read the values in that MCA bank) and percolating the error (e.g., by sending an interrupt to the OS, if warranted by the error and requested by the OS).

In one example, on a threshold overflow or deferred error interrupt, the MCA bank can notify its processing core, and that core can send an interrupt to the management core/firmware. The processing core can then continue normal operation.

In another example, on a Machine Check Exception (MCE), the core will query the MCA banks and send an interrupt to the management core/firmware. The management core can (optionally) read the banks with valid errors, and then uncloak one or more MCA banks, causing microcode to generate an MCE to the operating system. From the OS perspective, the MCE can be taken precisely, as normal (e.g., as if the management core did not affect the error flow). In some examples, the management core can read MCA registers from a processor core without directly halting the core.

In one implementation, a device for an error handling management core includes a processor core, and a management core configured to detect an error of the processor core, and process the error independently from the processor core.

In some examples, the management core is further configured to cloak or uncloak the error from an operating system. In some examples, the management core is configured to cloak or uncloak the error from the operating system based on an error policy. In some examples, the error policy is programmable. In some examples, the error policy corresponds to microcode in the management core.

In some examples, cloaking the error comprises preventing the operating system from reading an error state for the error. In some examples, cloaking the error comprises suppressing an error interrupt to the operating system. In some examples, uncloaking the error comprises allowing the operating system to read an error state for the error. In some examples, uncloaking the error comprises sending an error interrupt to the operating system.

In some examples, the device includes a register for storing an error state corresponding to the error interrupt. In some examples, processing the error further comprises accessing the register to read the error state. In some examples, processing the error further comprises instructing the processor core to continue operations

In one implementation, a system for an error handling management core includes a memory, and a processor including a processor core, a register for storing an error state of the processor core, and a management core. In some examples, the management core is configured to detect an error of the processor core, control read access to the error state in the register, and process the error independently from the processor core.

In some examples, the management core is configured to control read access to the error state based on an error policy. In some examples, the error policy corresponds to programmable microcode in the management core. In some examples, the management core is further configured to cloak the error from an operating system based on the error policy by preventing the operating system from reading the error state and suppressing an error interrupt to the operating system.

In some examples, the management core is further configured to uncloak the error from an operating system based on the error policy by allowing the operating system to read an error state for the error and sending an error interrupt to the operating system. In some examples, processing the error further comprises accessing the register to read the error state and instructing the processor core to continue operations.

In one implementation, a method for an error handling management core includes (i) detect, by a management core of a processor, an error of a processor core of the processor, (ii) controlling, by the management core, read access to an error state in a register based on an error policy, and (iii) processing the error independently from the processor core while the processor core continues operations. In some examples, the method includes providing read access to the error state for an operating system.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAs that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A device comprising:
a processor core configured for processing tasks; and
a management core configured for management tasks exclusive of the processing tasks, and configured to:
detect an error of the processor core; and
process the error independently from the processor core running the processing tasks.

2. The device of claim 1, wherein the management core is further configured to cloak or uncloak the error from an operating system.

3. The device of claim 2, wherein the management core is configured to cloak or uncloak the error from the operating system based on an error policy.

4. The device of claim 3, wherein the error policy is programmable.

5. The device of claim 3, wherein the error policy corresponds to microcode in the management core.

6. The device of claim 2, wherein cloaking the error comprises preventing the operating system from reading an error state for the error.

7. The device of claim 2, wherein cloaking the error comprises suppressing an error interrupt to the operating system.

8. The device of claim 2, wherein uncloaking the error comprises allowing the operating system to read an error state for the error.

9. The device of claim 2, wherein uncloaking the error comprises sending an error interrupt to the operating system.

10. The device of claim 1, further comprising a register for storing an error state corresponding to the error.

11. The device of claim 10, wherein processing the error further comprises accessing the register to read the error state.

12. The device of claim 1, wherein processing the error further comprises instructing the processor core to continue operations.

13. A system comprising:
a memory; and
a processor comprising:
a processor core configured for processing tasks;
a register for storing an error state of the processor core; and
a management core configured for management tasks exclusive of the processing tasks, and configured to:
detect an error of the processor core;
control read access to the error state in the register; and
process the error independently from the processor core running the processing tasks.

14. The system of claim 13, wherein the management core is configured to control read access to the error state based on an error policy.

15. The system of claim 14, wherein the error policy corresponds to programmable microcode in the management core.

16. The system of claim 14, wherein the management core is further configured to cloak the error from an operating system based on the error policy by preventing the operating system from reading the error state and suppressing an error interrupt to the operating system.

17. The system of claim 14, wherein the management core is further configured to uncloak the error from an operating system based on the error policy by allowing the operating system to read an error state for the error and sending an error interrupt to the operating system.

18. The system of claim 13, wherein processing the error further comprises accessing the register to read the error state and instructing the processor core to continue operations.

19. A method comprising:
detect, by a management core of a processor that is configured for management tasks exclusive of processing tasks for a processor core of the processor, an error of the processor core of the processor;
controlling, by the management core, read access to an error state in a register based on an error policy; and
processing the error independently from the processor core while the processor core continues operations on the processing tasks.

20. The method of claim 19, further comprising providing read access to the error state for an operating system.
